(19) United States
(12) Patent Application Publication
(10) Pub. No.: US 2026/0362425 A1
(43) Pub. Date: Nov. 12, 2026

(54) ENERGY EFFICIENT MEASUREMENTS

(71) Applicant: QUALCOMM Incorporated, San Diego, CA (US)

(72) Inventors: Ahmed BEDEWY, Hillsborough, NJ (US); Navid ABEDINI, Basking Ridge, NJ (US); Mahmoud TAHERZADEH BOROUJENI, San Diego, CA (US); Xiaoxia ZHANG, San Diego, CA (US); Tao LUO, San Diego, CA (US)

(21) Appl. No.: 19/668,637

(22) Filed: May 5, 2026

Related U.S. Application Data
(60) Provisional application No. 63/802,480, filed on May 8, 2025.

(51) Int. Cl. H04W 72/20; H04L 5/00; H04W 24/10

(52) U.S. Cl. CPC H04W 72/20; H04L 5/0051; H04W 24/10

(57) ABSTRACT

This disclosure provides methods, components, devices and systems for energy efficient measurements. For example, a network entity may configure a user equipment (UE) with a first set of subcomponents and a first set of reference signals, and a second set of subcomponents for which the UE is not to perform actual measurements. The UE may generate metrics without measuring the second set of subcomponents. The UE may report the metrics for the second set of subcomponents, or may generate one or more parameters for wireless communications based on the generated hypothetical metrics for the second set of subcomponents. In some examples, the network entity may configure the UE to provide information corresponding to the second set of subcomponents, and the network entity may generate metrics for the second set of subcomponents.

### CROSS REFERENCE

This Patent Application claims the benefit of U.S. Provisional Patent Application No. 63/802,480 by Bedewy et al., entitled “ENERGY EFFICIENT MEASUREMENTS,” filed May 8, 2025, assigned to the assignee hereof, and expressly incorporated herein.

### TECHNICAL FIELD

This disclosure relates generally to wireless communication, and more specifically to systems, devices, methods, and techniques associated with energy efficient measurements.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol. Some wireless communications may support measurement of one or more reference signals.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources, generating the first set of metrics for the first set of subcomponents based on one or more measurements performed on the first set of reference signals, and generating the second set of metrics for the second set of subcomponents in accordance with the control signaling and one or more parameters for the second set of subcomponents.

A UE for wireless communications is described. The UE may include a processing system that includes processor circuitry and memory circuitry that stores code. The processing system may be configured to cause the UE to receive control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources, generate the first set of metrics for the first set of subcomponents based on one or more measurements performed on the first set of reference signals, and generate the second set of metrics for the second set of subcomponents in accordance with the control signaling and one or more parameters for the second set of subcomponents.

Another UE for wireless communications is described. The UE may include means for receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources, means for generating the first set of metrics for the first set of subcomponents based on one or more measurements performed on the first set of reference signals, and means for generating the second set of metrics for the second set of subcomponents in accordance with the control signaling and one or more parameters for the second set of subcomponents.

A non-transitory computer-readable medium storing code for wireless communications is described. The code may include instructions executable by one or more processors (e.g., directly, indirectly, without pre-processing, after pre-processing) to receive control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources, generate the first set of metrics for the first set of subcomponents based on one or more measurements performed on the first set of reference signals, and generate the second set of metrics for the second set of subcomponents in accordance with the control signaling and one or more parameters for the second set of subcomponents.

Some examples of the method, user equipment (UEs), and non-transitory computer-readable medium described herein may further include operations, features, means, or instructions for applying the one or more parameters to the one or more measurements performed on the first set of reference signals, where generating the second set of metrics for the second set of subcomponents may be based on the applying.

Some examples of the method, user equipment (UEs), and non-transitory computer-readable medium described herein may further include operations, features, means, or instructions for transmitting a report including the second set of metrics for the second set of subcomponents.

Some examples of the method, user equipment (UEs), and non-transitory computer-readable medium described herein may further include operations, features, means, or instructions for generating one or more communication parameters based on the second set of metrics and performing wireless communications in accordance with one or more transmission parameters.

A method for wireless communications by a UE is described. The method may include receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources, transmitting, based on the control signaling, one or more parameters corresponding to the second set of metrics, and refraining from performing measurements for the second set of subcomponents based on the control signaling.

A UE for wireless communications is described. The UE may include a processing system that includes processor circuitry and memory circuitry that stores code. The processing system may be configured to cause the UE to receive control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources, transmit, based on the control signaling, one or more parameters corresponding to the second set of metrics, and refrain from performing measurements for the second set of subcomponents based on the control signaling.

Another UE for wireless communications is described. The UE may include means for receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources, means for transmitting, based on the control signaling, one or more parameters corresponding to the second set of metrics, and means for refraining from performing measurements for the second set of subcomponents based on the control signaling.

A non-transitory computer-readable medium storing code for wireless communications is described. The code may include instructions executable by one or more processors to receive control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources, transmit, based on the control signaling, one or more parameters corresponding to the second set of metrics, and refrain from performing measurements for the second set of subcomponents based on the control signaling.

### BRIEF DESCRIPTION OF THE DRAWINGS

FIG. 1 shows an example of a wireless communication system.

FIG. 2 shows an example of a signaling diagram that supports energy efficient measurements.

FIG. 3 shows an example of a process flow that supports energy efficient measurements.

FIG. 4 shows a block diagram of a processing system that supports energy efficient measurements.

FIG. 5 shows a diagram of a system including a device that supports energy efficient measurements.

FIGS. 6-10 show flowcharts illustrating methods that support energy efficient measurements.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may support wideband communications. However, the network entity may enter a network energy saving (NES) mode, or the UE may be configured with consecutive or nonconsecutive subcomponents (e.g., subsets of frequency resources) within a wideband. Thus, the UE may not be able to, or may not be configured to, perform measurements of reference signals via some subcomponents. However, without some metrics (e.g., channel estimation, or other reports) corresponding to the unmeasured subcomponents, some procedures (e.g., scheduling, handover, or channel estimation) may fail or may be degraded.

Aspects of the subject matter described in this disclosure relate to generating hypothetical metrics for unmeasured subcomponents (e.g., calculated or estimated metrics that are not based on actually measuring some subcomponents). For example, the network entity may configure the UE with a first set of subcomponents (e.g., subsets of frequency resources, time resources, or other resources) that correspond to (e.g., are assigned to) a first set of reference signals, and a second set of subcomponents (e.g., subsets of frequency resources, time resources, or both) for which the UE is not to perform actual measurements (e.g., the second set of subcomponents may be muted or may correspond to cells that have entered an NES mode, or the UE may refrain from measuring one or more subcomponents to save energy). The UE may generate metrics without measuring the second set of subcomponents (e.g., based on a set of weight values, historical measurements of the second set of subcomponents, or actual measurements of the first set of subcomponents). The UE may report the metrics for the second set of subcomponents, or may generate one or more parameters for wireless communications based on the generated hypothetical metrics for the second set of subcomponents. In some examples, instead of the UE generating the hypothetical metrics for the second set of subcomponents, the network entity may configure the UE to provide information corresponding to the second set of subcomponents (e.g., one or more weight values, historical data, measurements of the first set of subcomponents), based on which the network entity may generate the second set of metrics for the second set of subcomponents.

Particular aspects of the subject matter described in this disclosure can be implemented to realize one or more of the following potential advantages. In some examples, by generating the hypothetical metrics for the unmeasured subcomponents, the described techniques can be used to improve the accuracy of one or more procedures (e.g., channel estimation, handover, beamforming, or scheduling). Techniques described herein may therefore improve throughput, increase the reliability of wireless communications, decrease system latency, and improve user experience.

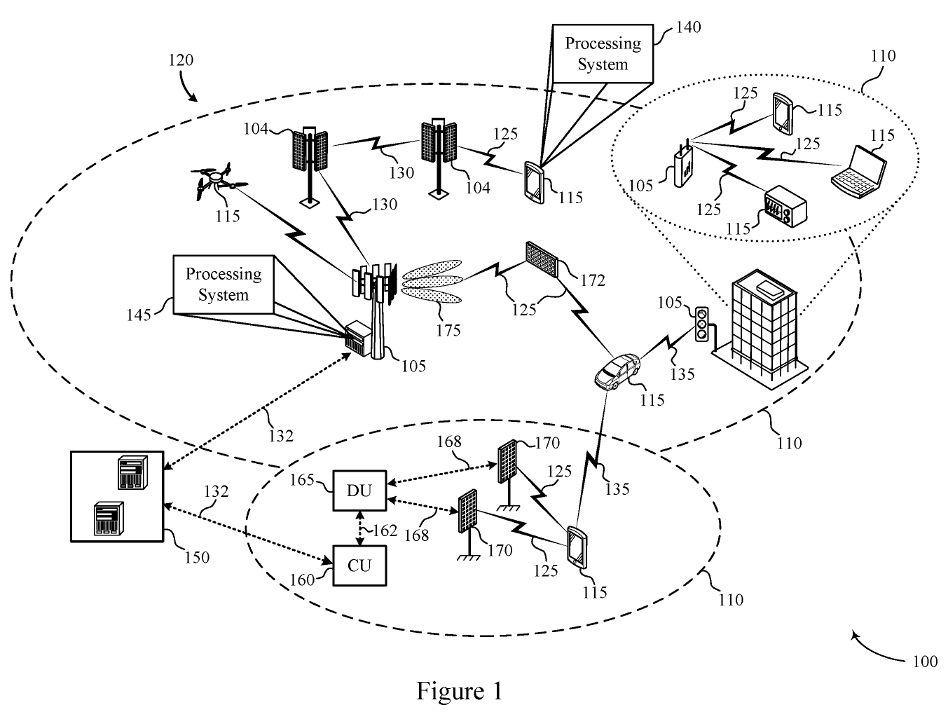

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for energy efficient measurements. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support techniques for generating and utilizing (e.g., and in some cases, reporting) hypothetical metrics for unmeasured components. Such techniques may therefore improve throughput, increase the reliability of wireless communications, decrease system latency, and improve user experience.

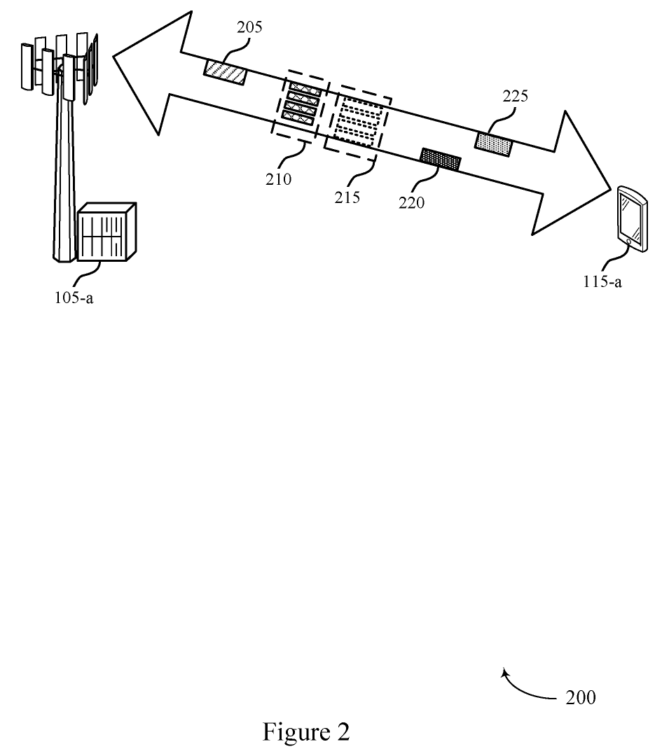

FIG. 2 shows an example of a signaling diagram 200 that supports energy efficient measurements. The signaling diagram 200 may implement, or be implemented by, aspects of the wireless communication system 100. For example, the signaling diagram 200 includes a UE 115-a and a network entity 105-a, which may be examples of corresponding devices described with reference to FIG. 1.

In some wireless communications systems (e.g., 6G systems), a UE 115 (e.g., the UE 115-a) may support and be configured to operate within a wide bandwidth. The UE 115-a may or may not measure all frequency resources (e.g., all frequency components, component carriers, or subcomponents in the frequency domain). For example, if the network entity 105-a is an NES network entity 105, then the network entity 105-a may mute one or more components or subcomponents (e.g., may not transmit reference signal via muted frequency resources, cells, subbands, components, component carriers, or subcomponents). In some examples, for UE energy savings, the UE 115-a may refrain from performing one or more measurements (e.g., may skip measuring some frequency resources, cells, subbands, components, component carriers, or subcomponents). However, metrics corresponding to skipped resources (e.g., components or subcomponents) may still be valuable or important to wireless communications. For example, channel estimation or quality, or quality of service metrics may rely on accurate measurements, which the UE 115-a may not perform or may not be able to perform for some components or subcomponents.

Techniques described herein support generation of metrics without measurement for some components or subcomponents. Metrics generated for one or more unmeasured components or subcomponents may be referred to herein as hypothetical metrics. As described herein, the network entity 105-a may provide the UE 115-a with a first set of subcomponents (e.g., the subcomponents 210) with associated reference signals to measure. The Network entity 105-a may also provide the UE 115-a with a second set of subcomponents (e.g., the subcomponents 215) for which the UE 115-a may skip measurements (e.g., refrain from performing measurements). In accordance with techniques (e.g., a framework) described herein, the UE 115-a may evaluate the quality of the unmeasured subcomponents based on one or more hypothetical metrics. The UE 115-a may also evaluate the performance of the hypothetical metrics (e.g., calculation of estimate errors). In some examples, as described herein, the UE 115-a may be provided with a set of conditions, and if the conditions are satisfied the UE 115-a may report evaluation of the hypothetical metrics, or the UE 115-a may indicate conditions or violation events to the network entity 105-a and may follow instructions to improve estimation of the quality of the unmeasured subcomponents.

As described herein, the term subcomponents may refer to a set or subset of resources (e.g., time resources, frequency resources). For example, the term subcomponent may refer to a set or subset of time and frequency resources (e.g., corresponding to a set of reference signals), or may refer to sets or subsets of frequency resources, such as channels, subchannels, bands, subbands, bandwidths, BWPs, components, component carriers, or subcomponents.

UE measurements may support network performance, and may support quality of service (QoS) for wireless communications, enhancing user experience. Different metrics may be generated and reported by the UE 115-a as a result of measurements. Such reports may include L1/L3 reference signal receive power (RSRP), reference signal receive quality (RSRQ), channel quality information (CQI), or block error (BLER). The UE 115-a may measure various types of signals to generate such measurements, metrics, and reports. For example, the network entity 105-a may transmit (e.g., via various subcomponents) one or more of primary synchronization signals (PSSs) (e.g., for UE detection of the presence of a cell and synchronization with timing for the detected cell), secondary synchronization signals (SSSs) (e.g., which provide additional information for the UE to identify the cell and synchronize with the frame structure), channel state information (CSI) reference signal (RS) (e.g., which may assist the UE in measuring channel quality and reporting channel quality to the network entity 105-a for adaptive modulation and coding), demodulation reference signals (DMRSs) (e.g., which may assist the UE 115-a in demodulating received data by providing reference points for channel estimation), phase tracking reference signals (PTRSs) (e.g., which may be used by the base station to measure uplink channel quality and improve uplink transmission parameters), CSI interference measurements (IMs) (e.g., which may support the UE 115-a in measuring interference levels and reporting interference levels to the network entity 105-a for interference management). As described herein, reference signals may refer to these reference signals, or any other reference signals.

UE measurements (e.g., of reference signals) may be utilized to improve network performance, improve reliability of connectivity, and enhance user experience. Measurements of reference signals may support various network operations such as scheduling, link adaptation, beamforming, carrier aggregation, dual connectivity, or handover. The UE 115-a (e.g., a CPE, a mobile UE) may support wideband operations or may be configured to operate within a wide bandwidth. In some examples, a single cell may span a large bandwidth including consecutive resource blocks (RBs). In some examples, a single cell may span a large bandwidth including nonconsecutive RBs (e.g., or chunks or segments of RBs). In some examples, the wireless communications system may support Frequency-Selective Isolation (FSI), virtual cells, or noncontiguous BWPs for CPE. In some examples, multiple cells may collectively span a large bandwidth including consecutive or nonconsecutive RBs.

In some examples (e.g., where the UE 115-a supports or is configured with a wide bandwidth), the network entity 105-a may configure the UE 115-a with a wideband frequency selective channel. In such examples, the UE 115-a may be expected to monitor, measure, and report channel and beam quality over smaller or different subcomponents of the bandwidth (e.g., for single-cell cases). If some subcomponents are muted or disabled by the network entity 105-a, if the network entity 105-a is operating in an NES mode, or if the UE 115-a is configured with consecutive or non-consecutive subcomponents of the wideband (e.g., among other examples), then some subcomponents may be unavailable for UE measurement. However, various network procedures (e.g., scheduling, link adaptation, beamforming, carrier aggregation, handover, or beam management) may suffer (e.g., without measurements and reports from the UE 115-a regarding muted or unavailable subcomponents, the network entity 105-a may not have access to sufficient information regarding channel estimates or other metrics, among other examples). Without such reported information, network operations may be degraded, which may result in poor channel estimation, decreased reliability of wireless signaling, failed handover procedures, poor link adaptation, decreased throughput or inefficient use of available system resources, increased system latency, and poor user experience. Without techniques described herein, network and UE energy consumption may increase. Techniques described herein support hypothetical metrics for skipped measurements.

The network entity 105-a may configure the UE 115-a with a first set of subcomponents 210 for which the UE 115-a is to perform measurements on one or more sets of reference signals. The network entity 105-a may also configure the UE 115-a with a second set of subcomponents 215 for which the UE 115-a is to calculate (e.g., and in some cases, report) one or more hypothetical metrics. In some examples, the control signaling 205 may configure (e.g., may include an indication or allocation of) the first set of subcomponents 210 and the second set of subcomponents 215. The first set of subcomponents 210 and the second set of subcomponents 215 may correspond to different frequency resources, and the same or overlapping time resources. In some examples, the first set of subcomponents 210 and the second set of subcomponents 215 may correspond to different time resources and the same or different frequency resources. In some examples, a subcomponent may simply refer to a segment or range of frequency resources (e.g., without reference to time or spatial resources). In some examples, subcomponents may be beam specific. In some examples, subcomponents may be specific to time resources, frequency resources, or other resources, of one or more sets of reference signals.

Each subcomponent (e.g., of the first set of subcomponents 210 and the second set of subcomponents 215) may be associated with the same or different bands, cells, or component carriers (e.g., and such an association may be indicated in the control signaling 205, via other control signaling, or may be defined in one or more standards documents). Some subcomponents 210 or subcomponents 215 may not be assigned with downlink reference signals for measurements. Some subcomponents 215 may be assigned with downlink reference signals but the assigned downlink reference signals may not be transmitted very frequently (e.g., in accordance with a large periodicity or only scheduled rarely), or the assigned reference signals may be transmitted in some beam directions (e.g., but not in other beam directions). Some of the subcomponents 215 may correspond to different beams, or different spatial resources (e.g., in addition to or instead of time and frequency resources). In some examples, the second set of subcomponents 215 may be assigned with full or frequent downlink reference signals, and the UE 115-a may determine to skip (e.g., fully skip, partially skip, or to skip some or to skip during some occasions but not others) associated measurements (e.g., and to instead determine hypothetical metrics for the second set of subcomponents 215).

The UE 115-a may evaluate hypothetical metrics for the second set of subcomponents 215 (e.g., without measuring reference signals assigned to the second set of subcomponents). In some examples, the UE 115-a may generate the metrics for the second set of subcomponents 215 based on some instructions from the network entity 105-a (e.g., via the control signaling 205 or via other control signaling).

In some examples, the network entity 105-a may generate the hypothetical metrics corresponding to the subcomponents 215. The network entity 105-a may generate the hypothetical metrics based on supplementary information provided by the UE 115-a. For example, the UE 115-a may transmit a report message which may indicate one or more measurements (e.g., corresponding to the subcomponents 210) or historical data, and the network entity 105-a may generate hypothetical metrics for the second set of subcomponents based on the supplementary information reported by the UE 115-a.

Hypothetical metrics (e.g., generated estimations or calculated metrics for the subcomponents 215) may be based on interpolation or extrapolation of measurements on other subcomponents or adjacent subcomponents (e.g., one or more of the subcomponents 210 or other subcomponents). The hypothetical metrics may be based on a function or a model which may be determined or provided by the network entity 105-a or may be generated by the UE 115-a, or may be defined in one or more standards. The UE 115-a may input one or more parameters (e.g., measurement values from one or more subcomponents such as the subcomponents 210, historical values, estimated values, provided inputs from the network entity 105-a, or weight values) into the model and may generate hypothetical metrics for the subcomponents 215.

In some examples, the network entity 105-a may provide (e.g., via the control signaling 205) instructions for generating the hypothetical metrics. For example, the network entity 105-a may indicate, for each subcomponent 215, how to determine one or more metrics based on other subcomponents (e.g., nearby subcomponents, such as the subcomponents 210). The instructions for generating the metrics for the subcomponents 215 may include a set of weight values (e.g., w_1, . . .,w_n) for the associated subcomponents 215 (e.g., s_1, . . .,s_n). For example, the control signaling 205 may include a set of weight values for each of the subcomponents 215. In some examples, a set of weights (e.g., function parameters or model parameters) may be based on prior measurements of the skipped subcomponent measurements (e.g., an AI or ML model may be used), channel quality of measured subcomponents 210, or an amount of correlation between measured and unmeasured subcomponents. In some examples, weight values may be a result of a calculation (e.g., an optimization problem) where the network entity 105-a provides the UE 115-a with some supplementary information (e.g., problem convexity), to assist in determining the suitable weight values. In some examples, the UE 115-a may report the determined weights. For example, the UE 115-a may generate a set of weight values for the subcomponents 215, and may report the weight values to the network entity 105-a (e.g., via a report message 220).

In some examples, the network entity 105-a may provide the UE 115-a with more than one set of weights, and instructions to assist the UE 115-a in selecting one of the sets of weights. For example, the network entity 105-a may provide the UE 115-a (e.g., via the control signaling 205 or via separate control signaling) with two sets of candidate weights (e.g., W1 and W2). The control signaling 205 (e.g., or other control signaling) may also include instructions (e.g., one or more rules or conditions) on when to use (e.g., how to select) the different candidate weights. For example, the UE 115-a may use a first set of weight values (e.g., W1) if the quality of some or all of other measured subcomponents 210 satisfy (e.g., exceed) a given threshold; otherwise the UE 115-a may use a second set of weight values (e.g., W2).

In some examples, the UE 115-a may generate (e.g., determine, calculate, or otherwise obtain) the weight values (e.g., without the weight values being configured by the network entity 105-a). The UE 115-a may generate the weight values based on prior measurements, or another estimation method. In some examples, the UE 115-a may share the determined weight values with the network entity 105-a (e.g., via a report message 220). Upon receiving a report of the weight values generated by the UE 115-a, the network entity may calculate the hypothetical metrics for the subcomponents 215. In some examples, the network entity 105-a may transmit an indication to the UE 115-a that the network entity 105-a has acknowledged (e.g., approved) the reported weight values, or the network entity 105-a may indicate one or more modifications to the reported weight values, and the UE 115-a may then calculate the hypothetical metrics for the subcomponents 215 using the reported weight values (e.g., if the network entity 105-a acknowledged the reported weight values) or using the modified weight values (e.g., if the network entity 105-a transmitted a responsive indication of one or more modifications to the reported weight values). In some examples, the UE 115-a may also share (e.g., report) some supplementary information to assist the network entity 105-a in determining the weight values. The supplementary information may include prior measurements or a function of prior measurements for unmeasured subcomponents 215.

The hypothetical metrics may be L1/L3 RSRP, RSRQ, interference metrics, SINR, PL, CQI, PMI, or rank. In some examples, the network entity 105-a may provide (e.g., via the control signaling 205) one or more additional parameters based on which the UE 115-a is to generate the hypothetical metrics for the subcomponents 215. For example, the network entity 105-a may transmit an indication of transmit power, bandwidth, or quantity of transmit ports, for the subcomponents 215, based on which the UE 115-a may be able to generate the hypothetical metrics for the subcomponents 215. In some examples, the UE 115-a (e.g., autonomously or as indicated by the network entity 105-a may adjust the weight values for generating the hypothetical metrics or the hypothetical metrics themselves (e.g., based on one or more events or conditions, such as a mobility status, traffic, QoS-related information, or a current energy level of the UE 115-a or the network entity 105-a).

The UE 115-a may report an evaluation of the hypothetical metrics to the network entity 105-a. In some examples, the UE 115-a may utilize the hypothetical metrics to calculate one or more additional parameters. For example, the UE 115-a may utilize a hypothetical metric such as path loss for the subcomponents 215 to determine an uplink transmit power control for the subcomponents 215 (e.g., without reporting the hypothetical pathloss to the network entity 105-a. In some examples, the UE 115-a may take another action based on the hypothetical metrics. For example, the UE 115-a may take an action based on one or more conditions or rules (e.g., if hypothetical metrics satisfy one or more thresholds, the UE 115-a may perform one or more functions or actions). In some examples, the network entity 105-a may generate the hypothetical metrics (e.g., based on supplementary information provided by the UE 115-a), in which case the network entity 105-a may use the hypothetical metrics to calculate other parameters.

In some examples, the UE 115-a may be provided with different sets of parameters or values, which may be configured (e.g., utilized) based on whether the UE 115-a has performed actual measurements or used hypothetical metrics. For example, the network entity 105-a may indicate to the UE 115-a (e.g., via the control signaling 205) various candidate configurations to calculate uplink transmit power (e.g., or another communication parameter). Whether the UE utilizes a first configuration to calculate the uplink transmit power or a second configuration to calculate the uplink transmit power may depend on whether the UE 115-a has calculated one or more metrics based on actual measurements (e.g., of the subcomponents 210) or based on hypothetical metrics (e.g., for the subcomponents 215). But providing candidate configurations (e.g., different calculation models), the network entity 105-a may be able to compensate for any errors in the hypothetical metrics.

In some examples, the UE 115-a may transmit a conditional report based on hypothetical metric performance. For example, the network entity 105-a may indicate (e.g., via the control signaling 205) conditions or instructions for how to report the evaluation of the hypothetical metrics. The UE 115-a may support performance monitoring for estimation or calculation of the hypothetical metrics. For instance, the network entity 105-a may transmit one or more reference signals (e.g., sporadic reference signals) via the subcomponents 215 so that the UE 115-a may assess the quality of the interpolation or extrapolation of the unmeasured subcomponents 215. The UE 115-a may perform actual measurements of the sporadic reference signals transmitted via the subcomponents 215, and may compare the hypothetical metrics (e.g., which may be provided by the network entity 105-a or generated by the UE 115-a) to the estimated hypothetical metrics.

Based on the comparison, the UE 115-a may identify one or more errors (e.g., difference between the hypothetical metrics and the actual measured or estimated value). Upon identifying the errors, the UE 115-a may report the errors (e.g., via the report message 220. For example, the UE 115-a may report the errors, or may report the errors along with the hypothetical metrics (e.g., regardless of the error values). In some examples, the errors may be reported periodically, or based on receiving a request for the reported errors from the network entity 105-a. In some examples, the UE 115-a may be provided (e.g., via the control signaling 205) with one or more conditions. If the conditions are satisfied (e.g., if the errors are below or above a threshold), then one or more behaviors may be triggered at the UE 115-a. The one or more behaviors may include (e.g., if the conditions are satisfied, such as if the errors are below or above a threshold), reporting the errors, requesting (e.g., via an uplink (UL) wakeup signal (WUS)) more frequently transmitted reference signals from the network entity 105-a, measuring all subcomponents (e.g., including the subcomponents 215), applying a change to the hypothetical metrics (e.g., changing the weight values, changing the metric to be measured, or changing the set of subcomponents that can be excluded from measurements), or indicating that the conditions have been satisfied (e.g., via the report message 220) in which case the network entity 105-a may reconfigure the UE 115-a (e.g., via the message 225). For instance, the UE may report the errors or may report that the conditions are satisfied, and the message 225 may indicate one or more updated weight values, updated metrics, or updated sets of subcomponents). Errors may be defined across all subcomponents, across a set of subcomponents, or per subcomponent. Thresholds (e.g., or conditions), may also be defined across all subcomponents, across a set of subcomponents, or per subcomponent.

Techniques described herein may be performed for downlink measurements, uplink measurements, or other measurements. For example, the techniques described herein may also be performed for uplink measurements performed by the network entity 105-a. In such examples, the UE 115-a may transmit reference signals via a first set of subcomponents, and the network entity 105-a may perform measurements on the first set of subcomponents (and may generate estimated hypothetical metrics for another set of subcomponents). Techniques described herein may be applied at a subband level, in which case the UE 115-a may be provided with a set of subbands (e.g., within the one or more subcomponents), that are to be excluded from measurements and for which the UE 115-a generates associated hypothetical metrics for evaluation. In some examples, the conditions described herein, or the configuration of measurement and generation of hypothetical metrics, may be valid for a time period, may be area specific, UE specific, or UE type specific (e.g., CPE UEs). In some examples, the techniques described herein may be configurable, preconfigurable, or reconfigurable, or any combination thereof.

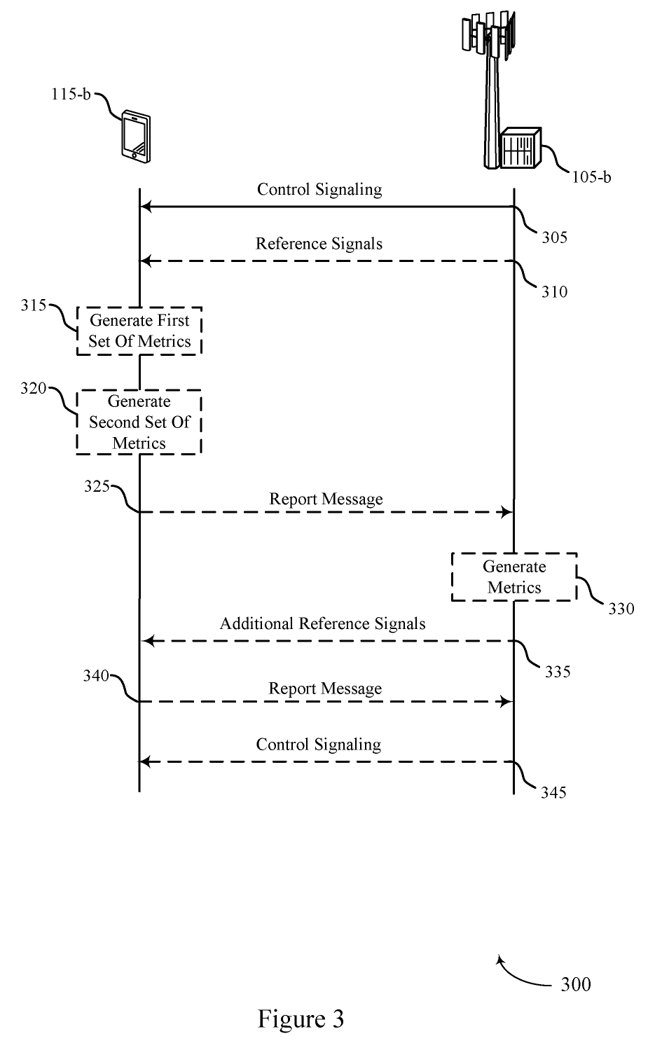

As described in greater detail with reference to FIG. 3, the network entity 105-a may provide the UE 115-a with configurations, conditions, or thresholds, as described herein, via dedicated RRC signaling, or broadcast signaling (e.g., SIB signaling, UE specific broadcast configuration). In some examples, configuration or reconfiguration may be autonomous or implicit, or may be explicitly indicated based on an index value to a set of preconfigured sets of parameters (e.g., preconfigured sets of subcomponents, reference signals, and associated hypothetical metrics. For instance, one or more candidate sets of subcomponents, reference signals corresponding to the respective sets of subcomponents, hypothetical metrics to generate for each set of subcomponents, or a combination thereof, may be configured by the network entity 105-a (e.g., via RRC signaling, SIB signaling, or other broadcast signaling) or may be preconfigured in accordance with one or more standards documents, and the network entity 105-a may transmit a message (e.g., the control signaling 205) with one or more index values indicating one of the candidate configurations. The configuration may be provided via SIB or dedicated RRC signaling. In some examples, the UE 115-a may be provided with one or multiple sets of configurations. If one other configuration is provided, then implicit reconfiguration may be triggered by reception of downlink signaling. If more than one configuration is provided, then a follow-up downlink signal may indicate the index to the configuration to be used by the UE 115-a.

In some examples, the network entity 105-a may explicitly indicate to the UE 115-a when to start and when to end the generation of hypothetical resources in accordance with the configuration. The indication may be provided via paging signaling, dedicated signaling, system information (SI), downlink control information (DCI) signaling, or any combination thereof. The indication may be UE-specific, or may be provided to a group of UEs (e.g., CPE UEs), or area specific.

The UE may transmit the report message 220 via dedicated RRC signaling, PUCCH signaling, or PUSCH signaling. The UE 115-a may transmit a media access control (MAC) control element (CE) that includes a subcomponent index associated with the hypothetical metric evaluation. The UE 115-a may indicate support for the techniques described herein (e.g., via dedicated RRC signaling or another uplink message), based on which the network entity 105-a may transmit a configuration (e.g., an indication of the subcomponents 215). In some examples, capability to support techniques described herein (e.g., generation of hypothetical metrics) may be indicated implicitly by a UE type of the UE 115-a.

In some examples, one or more UEs 115 may collaborate to support the techniques described herein. In such examples, the network entity 105-a may provide the UE with multiple (e.g., two) different options of hypothetical metrics, or weight values. The network entity 105-a may instruct the UE 115-a to use the first option if the UE 115-a will rely on its own measurements, or to use the second option if the UE 115-a will rely on its own measurements as well as other measurements from other collaborating UEs 115. The network entity 105-a may determine that one or more UEs 115 are collaborating, or may determine that one or more UEs 115 are collocated, and may use the collocation or collaboration information in determining which hypothetical metrics, a set of subcomponents 215, or both, for each collaborating UE 115. If collaborating UEs 115 share measurements, then the hypothetical metrics may be a function of overall measurements by all collaborating UEs 115. Weight values based on using measurements from other UEs 115 may be based on a distance between collaborating UEs 115 or RSRP measurement metrics between the collaborating UEs.

FIG. 3 shows an example of a process flow 300 that supports energy efficient measurements. The process flow 300 may implement, or be implemented by, aspects of the wireless communications system 100, the signaling diagram 200, or both. For example, the process flow 300 may include a network entity 105-b and a UE 115-b, which may be examples of corresponding devices described with reference to FIGS. 1 and 2.

In some examples, as described in greater detail with reference to FIG. 2, the UE 115-b may generate hypothetical metrics for one or more subcomponents without performing measurements.

At 305, the UE 115-b may receive control signaling (e.g., RRC signaling, SIB signaling, or dedicated broadcast signaling) indicating a first set of subcomponents for which the UE is to measure a first set of metrics and a second set of subcomponents for which the UE is to estimate without measurement a second set of metrics. The first set of subcomponents may indicate (e.g., correspond to or be assigned to) a first set of resources corresponding to a first set of reference signals and the second set of subcomponents may indicate (e.g., correspond to or be assigned to) a second set of resources.

In some examples, the control signaling 305 may include an explicit indication of the one or more parameters with which the UE 115-b is to generate the second set of metrics without measurement (e.g., a set of weight values or multiple sets of weight values, among other examples). In some examples, the control signaling at 305, the control signaling at 310, or both, may include an indication of one or more conditions or thresholds based on which the UE 115-b is to generate the second set of metrics, report the second set of metrics, or report errors, among other examples.

In some examples, the UE 115-b may determine (e.g., autonomously) based on the control signaling the second set of metrics. In some examples, the control signaling may explicitly indicate the metrics that the UE 115-b is to generate. In some examples, the control signaling may include an explicit indication of the set of weights or other parameters that the UE 115-b is to use to generate the metrics. In some examples, the UE 115-b may autonomously generate or identify the one or more parameters to use to generate the second set of metrics.

In some examples, initial control signaling (e.g., RRC signaling, SIB signaling, or broadcast signaling) may include configuration information, such as sets of candidate metrics to be generated, or sets of subcomponents for which measurements are not required, or sets of weight values, among other examples. In such examples, additional control signaling (RRC signaling, SIB signaling, MAC-CE signaling, or DCI signaling) may indicate which of the candidate configurations the UE 115-b is to use to generate the second set of metrics.

In some examples, the control signaling may indicate a time duration during which the configuration is valid, and upon expiration of the time duration the UE 115-b may resume performing measurements via both the first set of subcomponents and the second set of subcomponents.

At 315, the UE 115-b may generate the first set of metrics for the first set of subcomponents based on measurements performed on the first set of reference signals via the first set of subcomponents. For example, at 310 the UE 115-b may receive the first set of reference signals via the first set of subcomponents, and may generate the first set of metrics based thereon.

At 320, the UE 115-b may generate a second set of metrics for the second set of subcomponents in accordance with the control signaling and one or more parameters (e.g., a set of weight values, or another set of parameters) for the second set of subcomponents.

The UE 115-b may apply the one or more parameters to the measurements performed on the first set of reference signals, and the second set of metrics may be generated based thereon. In some examples, the control signaling received at 305 may include an indication of the parameters (e.g., the weight values for the second subset of subcomponents). In some examples, the control signaling (e.g., received at 305) may include various sets of candidate parameters (e.g., weight values), and the UE 115-b may select the parameters for generating the second set of metrics from the sets of candidate parameters (e.g., based on an instruction received from the network entity 105-b, or based on one or more conditions or thresholds, or based on measurements performed on the first subset of subcomponents, among other examples).

In some examples, generating the second set of metrics may be based on historical measurements (e.g., of the second set of subcomponents), measurements of the first set of reference signals, instructions received from the network entity 105-b, or any combination thereof.

At 325, the UE 115-b may transmit a report message. The report message may include at least one of the second set of metrics for the second set of subcomponents or an indication of the parameters used to generate the second set of metrics (e.g., if the UE 115-b generates the set of weight values autonomously).

In some examples (e.g., instead of transmitting the report message), the UE 115-b may generate one or more communication parameters (e.g., uplink transmission parameters, or downlink reception parameters) based on the second set of metrics, and may perform wireless communications (e.g., uplink signaling, or downlink reception) in accordance with the generated communication parameters.

At 335 the UE 115-b may receive a set of reference signals (e.g., additional reference signals) via the second set of subcomponents, and may perform a second set of one or more measurements for the second set of subcomponents. The UE 115-b may detect one or more errors corresponding to the second set of metrics. In some examples, the UE 115-b may transmit a report (e.g., at 340) indicating the errors, a request for additional reference signals via the second set of subcomponents for measurement, an indication of one or more updates to the second set of metrics or updates to the parameters (e.g., a request to update the metrics to be generated, a request for different parameters for generating the second set of metrics), or any combination thereof. In some examples, the report transmitted at 340 may indicate the errors, and the network entity 105-b may transmit (e.g., at 345) one or more updates to the parameters based on the reporting of the errors. In some examples, the UE 115-b may autonomously update the metrics or the parameters or both autonomously (e.g., without reporting or upon reporting the one or more errors). In some examples, the UE 115-b may wait to update the parameters, the metrics, or both, until control signaling at 345 indicates updates to the parameters or the metrics or both or confirms the proposed updates indicated by the UE 115-b at 340. In some examples, the report message transmitted at 340 may be transmitted if one or more errors satisfy one or more thresholds. In some cases, the thresholds may be configured via control signaling at 305.

In some examples, the network entity 105-b may generate the hypothetical metrics. For example, at 305 the network entity 105-b may transmit control signaling indicating a first set of subcomponents for which the UE 115-b is to measure a first set of metrics and a second set of subcomponents for which the UE 115-b is to estimate without measurement a second set of metrics, the first set of subcomponents indicating a first set of resources corresponding to a first set of reference signals and the second set of subcomponents indicating a second set of resources. At 325, the UE 115-b may transmit a message indicating one or more parameters corresponding to the second set of metrics (e.g., one or more weight values generated by the UE 115-b for the second set of subcomponents). The UE 115-b may refrain from performing measurements on the second set of subcomponents based on the control signaling. At 330, the network entity 105-b may generate the second set of metrics for the second set of subcomponents using the weight values indicated by the UE 115-b at 325. The one or more parameters may be based at least in part on one or more historical measurements, one or more measurements corresponding to the first set of metrics, one or more instructions for generating the one or more parameters received via the control signaling, or any combination thereof. The one or more parameters may be examples of weight values.

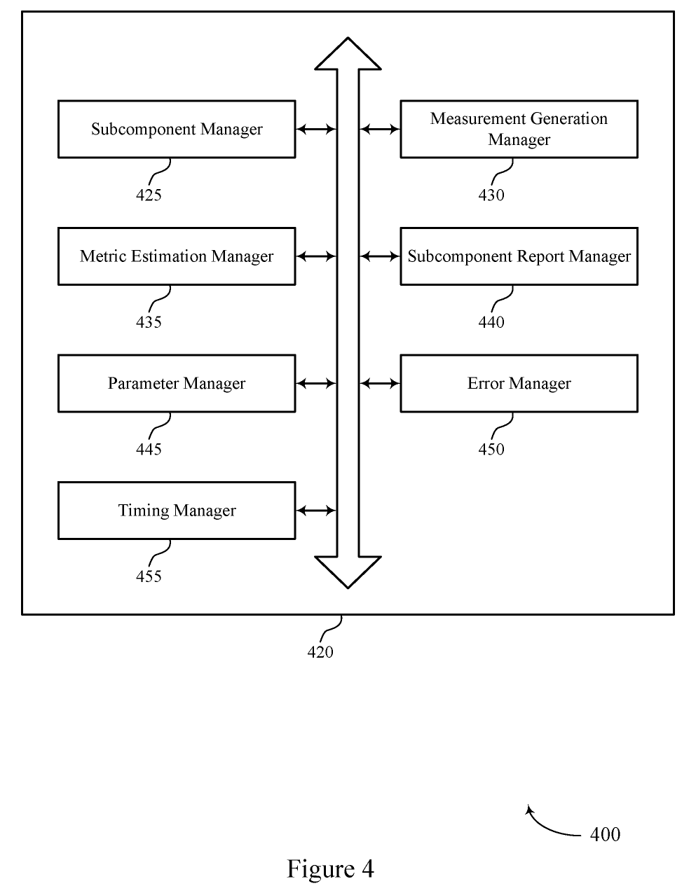

FIG. 4 shows an example 400 of a processing system 420 that supports energy efficient measurements. A processing system 420 may be an example of a processing system 140 (such as of a UE 115) and may include a subcomponent manager 425, a measurement generation manager 430, a metric estimation manager 435, a subcomponent report manager 440, a parameter manager 445, an error manager 450, a timing manager 455, or any combination thereof. A processing system 420, or various component thereof, may be an example of means for performing (such as a means for causing a UE 115 to perform) various techniques described herein.

The subcomponent manager 425 may be configured to cause the UE 115 to receive control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources. The measurement generation manager 430 may be configured to cause the UE 115 to generate the first set of metrics for the first set of subcomponents based on one or more measurements performed on the first set of reference signals. The metric estimation manager 435 may be configured to cause the UE 115 to generate the second set of metrics for the second set of subcomponents in accordance with the control signaling and one or more parameters for the second set of subcomponents.

In some examples, the metric estimation manager 435 may be configured to cause the UE 115 to apply the one or more parameters to the one or more measurements performed on the first set of reference signals, where generating the second set of metrics for the second set of subcomponents is based on the applying.

In some examples, the control signaling includes an indication of the one or more parameters.

In some examples, the parameter manager 445 may be configured to cause the UE 115 to select the one or more parameters from a set of multiple candidate parameters indicated in the control signaling based on the one or more measurements performed on the first set of reference signals.

In some examples, the parameter manager 445 may be configured to cause the UE 115 to generate the one or more parameters based on one or more historical measurements, the one or more measurements corresponding to the first set of metrics, one or more instructions for generating the one or more parameters received via the control signaling, or any combination thereof.

In some examples, the one or more parameters includes a set of weight values to be applied to the one or more measurements.

In some examples, the subcomponent report manager 440 may be configured to cause the UE 115 to transmit a report including the second set of metrics for the second set of subcomponents.

In some examples, the report includes an indication of the one or more parameters used to generate the second set of metrics.

In some examples, the parameter manager 445 may be configured to cause the UE 115 to generate one or more communication parameters based on the second set of metrics. In some examples, the parameter manager 445 may be configured to cause the UE 115 to perform wireless communications in accordance with one or more transmission parameters.

In some examples, the control signaling includes an indication of the second set of metrics. In some examples, generating the second set of metrics is based on the indication of the second set of metrics.

In some examples, the metric estimation manager 435 may be configured to cause the UE 115 to determine, based on the control signaling indicating the second set of subcomponents, the second set of metrics, where generating the second set of metrics is based on the determining.

In some examples, the error manager 450 may be configured to cause the UE 115 to receive a set of reference signals via the second set of subcomponents. In some examples, the error manager 450 may be configured to cause the UE 115 to perform a second set of one or more measurements for the second set of subcomponents. In some examples, the error manager 450 may be configured to cause the UE 115 to detect one or more errors corresponding to the second set of metrics based on a comparison with the second set of one or more measurements.

In some examples, the subcomponent report manager 440 may be configured to cause the UE 115 to transmit a report including an indication of the one or more errors, a request for additional reference signals via the second set of subcomponents, an indication of one or more updates to the second set of metrics, an indication of one or more updates to the one or more parameters, or any combination thereof.

In some examples, transmitting the report is based on the one or more errors satisfying a threshold offset from the first set of metrics.

In some examples, the subcomponent report manager 440 may be configured to cause the UE 115 to transmit a report including an indication of the one or more errors. In some examples, the parameter manager 445 may be configured to cause the UE 115 to receive a control message including an indication of one or more updates to the one or more parameters based on reporting the one or more errors.

In some examples, the control signaling includes an indication of a time duration during which the UE is to generate the first set of metrics with measurements and generate the second set of metrics without measurements. In some examples, the subcomponent report manager 440 may be configured to cause the UE 115 to perform additional measurements via both the first set of subcomponents and the second set of subcomponents upon expiration of the time duration.

In some examples, the subcomponent manager 425 may be configured to cause the UE 115 to receive control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources. The subcomponent report manager 440 may be configured to cause the UE 115 to transmit, based on the control signaling, one or more parameters corresponding to the second set of metrics. In some examples, the measurement generation manager 430 may be configured to cause the UE 115 to refrain from performing measurements for the second set of subcomponents based on the control signaling.

In some examples, the one or more parameters are based on the first set of metrics.

In some examples, the one or more parameters are based on one or more historical measurements, one or more measurements corresponding to the first set of metrics, one or more instructions for generating the one or more parameters received via the control signaling, or any combination thereof.

In some examples, the one or more parameters includes one or more weight values.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for generating and utilizing (e.g., and in some cases, reporting) hypothetical metrics for unmeasured components. Such techniques may therefore increase throughput, increase the reliability of wireless communications, decrease system latency, improve coordination between devices and improve user experience.

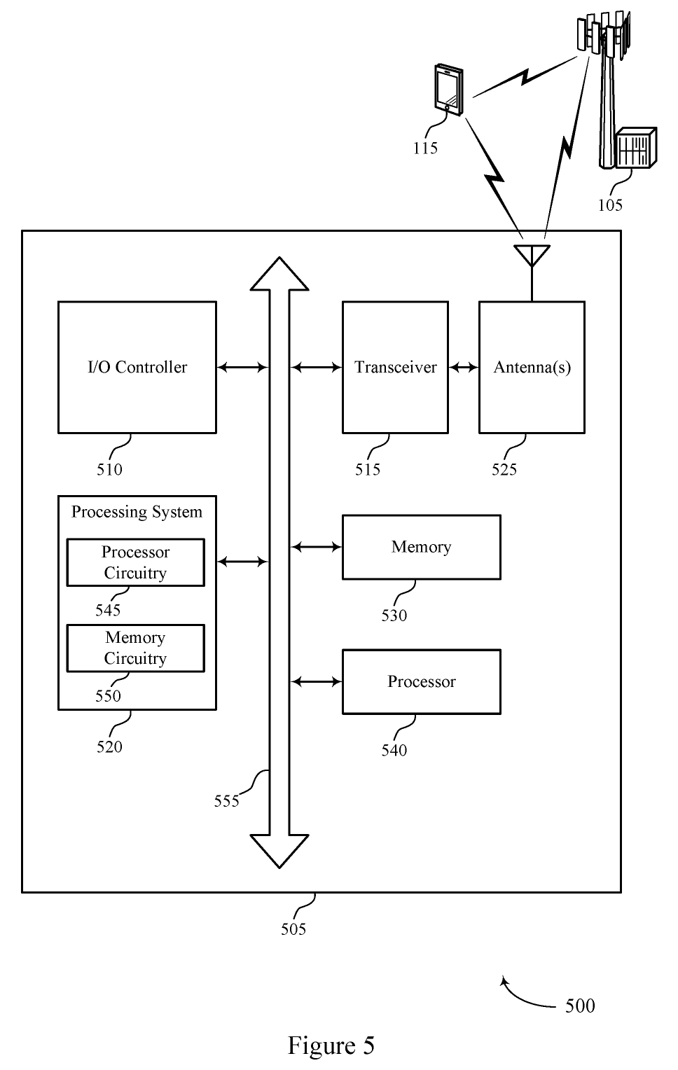

FIG. 5 shows an example of a system 500 including a device 505 that supports energy efficient measurements. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540 (e.g., directly, indirectly, without pre-processing, after pre-processing), cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support energy efficient measurements. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for generating and utilizing (e.g., and in some cases, reporting) hypothetical metrics for unmeasured components. Such techniques may therefore increase throughput, increase the reliability of wireless communications, decrease system latency, improve coordination between devices and improve user experience.

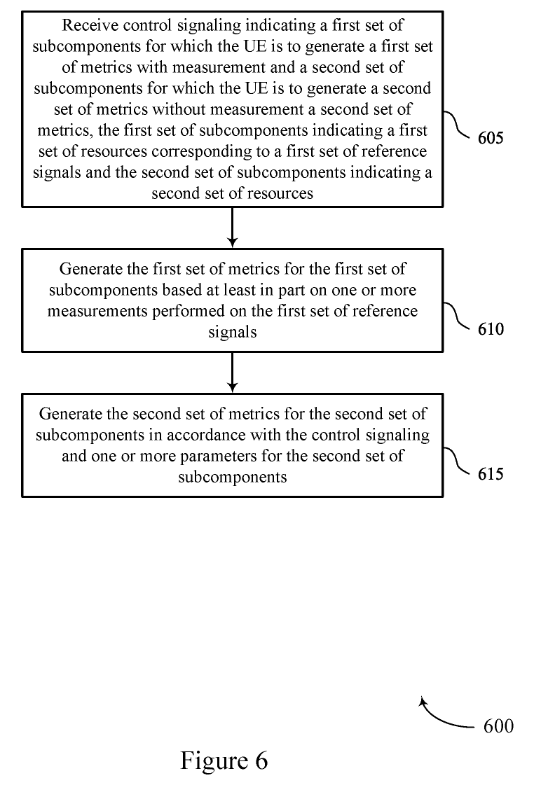

FIG. 6 shows an example of a method 600 that supports energy efficient measurements. Operations of the method 600 may be performed by a UE or its components (such as using a processing system configured to cause the UE 115 to perform one or more of the operations) as described herein.

At 605, the method may include receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources. In some examples, aspects of the operations of 605 may be performed by a subcomponent manager 425.

At 610, the method may include generating the first set of metrics for the first set of subcomponents based at least in part on one or more measurements performed on the first set of reference signals. In some examples, aspects of the operations of 610 may be performed by a measurement generation manager 430.

At 615, the method may include generating the second set of metrics for the second set of subcomponents in accordance with the control signaling and one or more parameters for the second set of subcomponents. In some examples, aspects of the operations of 615 may be performed by a metric estimation manager 435.

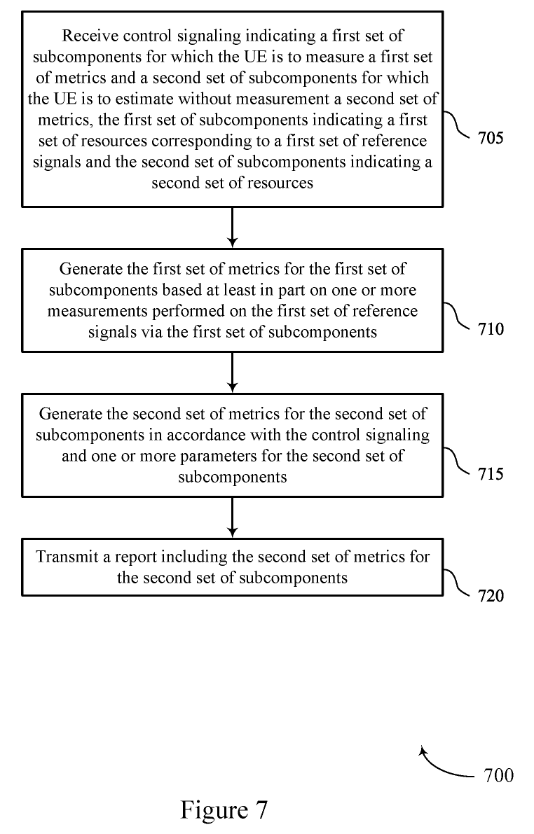

FIG. 7 shows an example of a method 700 that supports energy efficient measurements. Operations of the method 700 may be performed by a UE or its components (such as using a processing system configured to cause the UE 115 to perform one or more of the operations) as described herein.

At 705, the method may include receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources. In some examples, aspects of the operations of 705 may be performed by a subcomponent manager 425.

At 710, the method may include generating the first set of metrics for the first set of subcomponents based at least in part on one or more measurements performed on the first set of reference signals. In some examples, aspects of the operations of 710 may be performed by a measurement generation manager 430.

At 715, the method may include generating the second set of metrics for the second set of subcomponents in accordance with the control signaling and one or more parameters for the second set of subcomponents. In some examples, aspects of the operations of 715 may be performed by a metric estimation manager 435.

At 720, the method may include transmitting a report including the second set of metrics for the second set of subcomponents. In some examples, aspects of the operations of 720 may be performed by a subcomponent report manager 440.

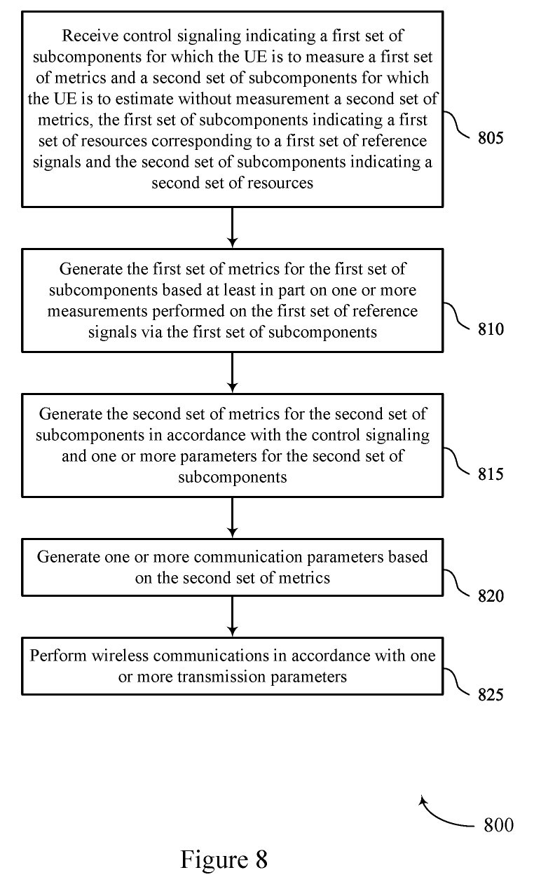

FIG. 8 shows an example of a method 800 that supports energy efficient measurements. Operations of the method 800 may be performed by a UE or its components (such as using a processing system configured to cause the UE 115 to perform one or more of the operations) as described herein.

At 805, the method may include receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources. In some examples, aspects of the operations of 805 may be performed by a subcomponent manager 425.

At 810, the method may include generating the first set of metrics for the first set of subcomponents based at least in part on one or more measurements performed on the first set of reference signals. In some examples, aspects of the operations of 810 may be performed by a measurement generation manager 430.

At 815, the method may include generating the second set of metrics for the second set of subcomponents in accordance with the control signaling and one or more parameters for the second set of subcomponents. In some examples, aspects of the operations of 815 may be performed by a metric estimation manager 435.

At 820, the method may include generating one or more communication parameters based on the second set of metrics. In some examples, aspects of the operations of 820 may be performed by a parameter manager 445.

At 825, the method may include performing wireless communications in accordance with one or more transmission parameters. In some examples, aspects of the operations of 825 may be performed by a parameter manager 445.

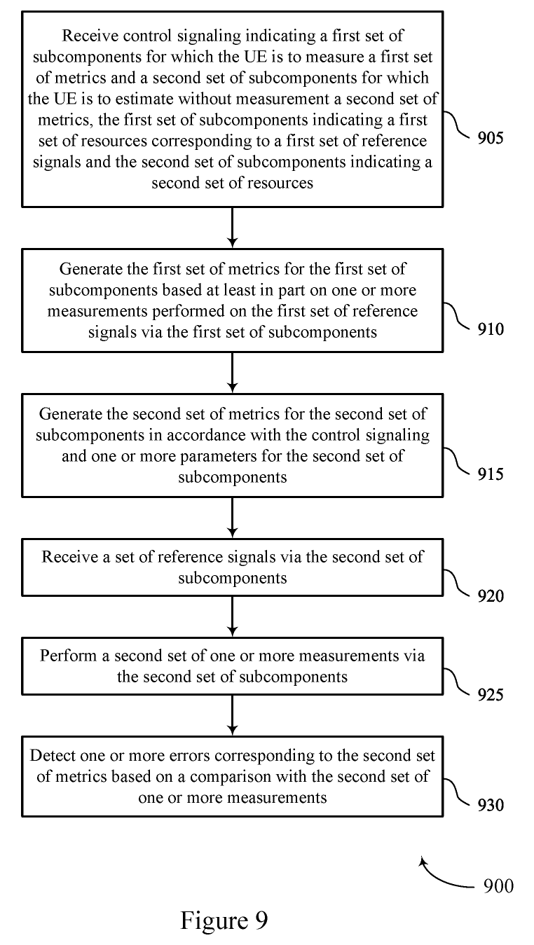

FIG. 9 shows an example of a method 900 that supports energy efficient measurements. Operations of the method 900 may be performed by a UE or its components (such as using a processing system configured to cause the UE 115 to perform one or more of the operations) as described herein.

At 905, the method may include receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources. In some examples, aspects of the operations of 905 may be performed by a subcomponent manager 425.

At 910, the method may include generating the first set of metrics for the first set of subcomponents based at least in part on one or more measurements performed on the first set of reference signals. In some examples, aspects of the operations of 910 may be performed by a measurement generation manager 430.

At 915, the method may include generating the second set of metrics for the second set of subcomponents in accordance with the control signaling and one or more parameters for the second set of subcomponents. In some examples, aspects of the operations of 915 may be performed by a metric estimation manager 435.

At 920, the method may include receiving a set of reference signals via the second set of subcomponents. In some examples, aspects of the operations of 920 may be performed by an error manager 450.

At 925, the method may include performing a second set of one or more measurements for the second set of subcomponents. In some examples, aspects of the operations of 925 may be performed by an error manager 450.

At 930, the method may include detecting one or more errors corresponding to the second set of metrics based on a comparison with the second set of one or more measurements. In some examples, aspects of the operations of 930 may be performed by an error manager 450.

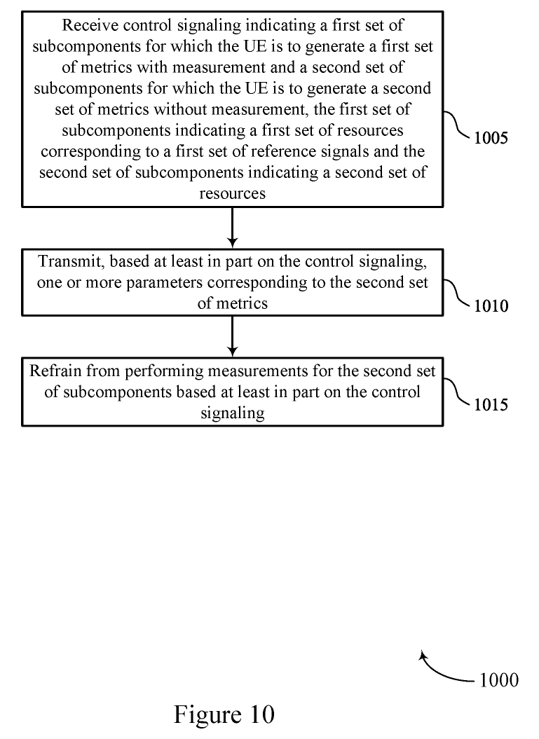

FIG. 10 shows an example of a method 1000 that supports energy efficient measurements. Operations of the method 1000 may be performed by a UE or its components (such as using a processing system configured to cause the UE 115 to perform one or more of the operations) as described herein.

At 1005, the method may include receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources. In some examples, aspects of the operations of 1005 may be performed by a subcomponent manager 425.

At 1010, the method may include transmitting, based at least in part on the control signaling, one or more parameters corresponding to the second set of metrics. In some examples, aspects of the operations of 1010 may be performed by a subcomponent report manager 440.

At 1015, the method may include refraining from performing measurements for the second set of subcomponents based at least in part on the control signaling. In some examples, aspects of the operations of 1015 may be performed by a measurement generation manager 430.

Implementation examples are described in the following numbered clauses:

Aspect 1: A method for wireless communications at a UE, comprising: receiving control signaling indicating a first set of subcomponents for which the UE is to generate a first set of metrics and a second set of subcomponents for which the UE is to generate a second set of metrics without measurement, the first set of subcomponents indicating a first set of resources corresponding to a first set of reference signals and the second set of subcomponents indicating a second set of resources; generating the first set of metrics for the first set of subcomponents based at least in part on one or more measurements performed on the first set of reference signals; and generating the second set of metrics for the second set of subcomponents in accordance with the control signaling and one or more parameters for the second set of subcomponents.

Aspect 2: The method of aspect 1, further comprising: applying the one or more parameters to the one or more measurements performed on the first set of reference signals, wherein generating the second set of metrics for the second set of subcomponents is based at least in part on the applying.

Aspect 3: The method of aspect 2, wherein the control signaling comprises an indication of the one or more parameters.

Aspect 4: The method of any of aspects 2 through 3, further comprising: selecting the one or more parameters from a plurality of candidate parameters indicated in the control signaling based at least in part on the one or more measurements performed on the first set of reference signals.

Aspect 5: The method of any of aspects 2 through 4, further comprising: generating the one or more parameters based at least in part on one or more historical measurements, the one or more measurements corresponding to the first set of metrics, one or more instructions for generating the one or more parameters received via the control signaling, or any combination thereof.

Aspect 6: The method of any of aspects 2 through 5, wherein the one or more parameters comprises a set of weight values to be applied to the one or more measurements.

Aspect 7: The method of any of aspects 1 through 6, further comprising: transmitting a report comprising the second set of metrics for the second set of subcomponents.

Aspect 8: The method of aspect 7, wherein the report comprises an indication of the one or more parameters used to generate the second set of metrics.

Aspect 9: The method of any of aspects 1 through 8, further comprising: generating one or more communication parameters based at least in part on the second set of metrics; and performing wireless communications in accordance with one or more transmission parameters.

Aspect 10: The method of any of aspects 1 through 9, wherein the control signaling comprises an indication of the second set of metrics, generating the second set of metrics is based at least in part on the indication of the second set of metrics.

Aspect 11: The method of any of aspects 1 through 10, further comprising: determining, based at least in part on the control signaling indicating the second set of subcomponents, the second set of metrics, wherein generating the second set of metrics is based at least in part on the determining.

Aspect 12: The method of any of aspects 1 through 11, further comprising: receiving a set of reference signals via the second set of subcomponents; performing a second set of one or more measurements for the second set of subcomponents; and detecting one or more errors corresponding to the first set of metrics based at least in part on a comparison with the second set of one or more measurements.

Aspect 13: The method of aspect 12, further comprising: transmitting a report comprising an indication of the one or more errors, a request for additional reference signals via the second set of subcomponents, an indication of one or more updates to the second set of metrics, an indication of one or more updates to the one or more parameters, or any combination thereof.

Aspect 14: The method of aspect 13, wherein transmitting the report is based at least in part on the one or more errors satisfying a threshold offset from the first set of metrics.

Aspect 15: The method of any of aspects 12 through 14, further comprising: transmitting a report comprising an indication of the one or more errors; and receiving a control message comprising an indication of one or more updates to the one or more parameters based at least in part on reporting the one or more errors.

Aspect 16: The method of any of aspects 1 through 15, wherein the control signaling comprises an indication of a time duration during which the UE is to generate the first set of metrics with measurements and generate the second set of metrics without measurements, further comprising: performing additional measurements via both the first set of subcomponents and the second set of subcomponents upon expiration of the time duration.

Aspect 17: A method for wireless communications at a UE, comprising: receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources; transmitting, based at least in part on the control signaling, one or more parameters corresponding to the second set of metrics; and refraining from performing measurements for the second set of subcomponents based at least in part on the control signaling.

Aspect 18: The method of aspect 17, wherein the one or more parameters are based at least in part on the first set of metrics.

Aspect 19: The method of any of aspects 17 through 18, wherein the one or more parameters are based at least in part on one or more historical measurements, one or more measurements corresponding to the first set of metrics, one or more instructions for generating the one or more parameters received via the control signaling, or any combination thereof.

Aspect 20: The method of any of aspects 17 through 19, wherein the one or more parameters comprises a set of weight values.

Aspect 21: A UE for wireless communications, comprising a processing system that includes processor circuitry and memory circuitry that stores code, the processing system configured to cause the UE to perform a method of any of aspects 1 through 16.

Aspect 22: A UE for wireless communications, comprising at least one means for performing a method of any of aspects 1 through 16.

Aspect 23: A non-transitory computer-readable medium storing code for wireless communications, the code comprising instructions executable by one or more processors to perform a method of any of aspects 1 through 16.

Aspect 24: A UE for wireless communications, comprising a processing system that includes processor circuitry and memory circuitry that stores code, the processing system configured to cause the UE to perform a method of any of aspects 17 through 20.

Aspect 25: A UE for wireless communications, comprising at least one means for performing a method of any of aspects 17 through 20.

Aspect 26: A non-transitory computer-readable medium storing code for wireless communications, the code comprising instructions executable by one or more processors to perform a method of any of aspects 17 through 20.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources;
generate the first set of metrics for the first set of subcomponents based at least in part on one or more measurements performed on the first set of reference signals; and
generate the second set of metrics for the second set of subcomponents in accordance with the control signaling and one or more parameters for the second set of subcomponents.

2. The UE of claim 1, wherein the one or more processors are individually or collectively further operable to execute the code to cause the UE to:
apply the one or more parameters to the one or more measurements performed on the first set of reference signals, wherein generating the second set of metrics for the second set of subcomponents is based at least in part on the applying.

3. The UE of claim 2, wherein the control signaling comprises an indication of the one or more parameters.

4. The UE of claim 2, wherein the one or more processors are individually or collectively further operable to execute the code to cause the UE to:
select the one or more parameters from a plurality of candidate parameters indicated in the control signaling based at least in part on the one or more measurements performed on the first set of reference signals.

5. The UE of claim 2, wherein the one or more processors are individually or collectively further operable to execute the code to cause the UE to:
generate the one or more parameters based at least in part on one or more historical measurements, the one or more measurements corresponding to the first set of metrics, one or more instructions for generating the one or more parameters received via the control signaling, or any combination thereof.

6. The UE of claim 2, wherein the one or more parameters comprises a set of weight values to be applied to the one or more measurements.

7. The UE of claim 1, wherein the one or more processors are individually or collectively further operable to execute the code to cause the UE to:
transmit a report comprising the second set of metrics for the second set of subcomponents.

8. The UE of claim 7, wherein the report comprises an indication of the one or more parameters used to generate the second set of metrics.

9. The UE of claim 1, wherein the one or more processors are individually or collectively further operable to execute the code to cause the UE to:
generate one or more communication parameters based at least in part on the second set of metrics; and
perform wireless communications in accordance with one or more transmission parameters.

10. The UE of claim 1, wherein:
the control signaling comprises an indication of the second set of metrics, and generating the second set of metrics is based at least in part on the indication of the second set of metrics.

11. The UE of claim 1, wherein the one or more processors are individually or collectively further operable to execute the code to cause the UE to:
determine, based at least in part on the control signaling indicating the second set of subcomponents, the second set of metrics, wherein generating the second set of metrics is based at least in part on the determining.

12. The UE of claim 1, wherein the one or more processors are individually or collectively further operable to execute the code to cause the UE to:
receive a set of reference signals via the second set of subcomponents;
perform a second set of one or more measurements for the second set of subcomponents; and
detect one or more errors corresponding to the second set of metrics based at least in part on a comparison with the second set of one or more measurements.

13. The UE of claim 12, wherein the one or more processors are individually or collectively further operable to execute the code to cause the UE to:
transmit a report comprising an indication of the one or more errors, a request for additional reference signals via the second set of subcomponents, an indication of one or more updates to the second set of metrics, an indication of one or more updates to the one or more parameters, or any combination thereof.

14. The UE of claim 13, wherein transmitting the report is based at least in part on the one or more errors satisfying a threshold offset from the first set of metrics.

15. The UE of claim 12, wherein the one or more processors are individually or collectively further operable to execute the code to cause the UE to:
transmit a report comprising an indication of the one or more errors; and
receive a control message comprising an indication of one or more updates to the one or more parameters based at least in part on reporting the one or more errors.

16. The UE of claim 1, wherein the control signaling comprises an indication of a time duration during which the UE is to generate the first set of metrics with measurements and generate the second set of metrics without measurements, and wherein the one or more processors are individually or collectively further operable to execute the code to cause the UE to:
perform additional measurements via both the first set of subcomponents and the second set of subcomponents upon expiration of the time duration.

17. A user equipment (UE), comprising:
one or more memories storing processor-executable code; and
one or more processors coupled with the one or more memories and individually or collectively operable to execute the code to cause the UE to:
receive control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources;
transmit, based at least in part on the control signaling, one or more parameters corresponding to the second set of metrics; and
refrain from performing measurements for the second set of subcomponents based at least in part on the control signaling.

18. The UE of claim 17, wherein the one or more parameters are based at least in part on the first set of metrics.

19. The UE of claim 17, wherein the one or more parameters are based at least in part on one or more historical measurements, one or more measurements corresponding to the first set of metrics, one or more instructions for generating the one or more parameters received via the control signaling, or any combination thereof.

20. A method for wireless communications at a user equipment (UE), comprising:
receiving control signaling indicating a first set of subcomponents for which the UE is to generate a first set of metrics with measurement and a second set of subcomponents for which the UE is to generate a second set of metrics without measurement, the first set of subcomponents indicating a first set of resources corresponding to a first set of reference signals and the second set of subcomponents indicating a second set of resources;
generating the first set of metrics for the first set of subcomponents based at least in part on one or more measurements performed on the first set of reference signals; and
generating the second set of metrics for the second set of subcomponents in accordance with the control signaling and one or more parameters for the second set of subcomponents.
